(19) United States
(12) Patent Application Publication
(10) Pub. No.: US 2019/0324773 A1
(43) Pub. Date: Oct. 24, 2019

(54) TETHERING TO A REMOTE SENSOR

(71) Applicant: Microsoft Technology Licensing, LLC, Redmond, WA (US)

(72) Inventors: Dejun ZHANG, Bellevue, WA (US); Ying N. CHIN, Bellevue, WA (US); Robert ZHU, Bellevue, WA (US); Lei ZHANG, Redmond, WA (US); Bin WANG, Bellevue, WA (US); Shu PENG, Redmond, WA (US); Daryl Alan WELSH, Bellevue, WA (US)

(21) Appl. No.: 15/958,199

(22) Filed: Apr. 20, 2018

(51) Int. Cl. G06F 9/451; G06F 9/448; H04L 29/06; H04L 29/08

(52) U.S. Cl. CPC G06F 9/451; H04L 67/125; H04L 63/0846; G06F 9/4494

(57) ABSTRACT

The disclosed technology provides a computing device for communication between an application executing at an application level of the computing device and a remote sensor located on a remote computing device. The remote sensor has a kernel level sensor interface supporting a sensor data format and is connected to the computing device via a communications network. The computing device includes an application interface supporting an application interface format. The application interface communicates sensor data with the application according to the application interface format. A tethered sensor driver translator translates the sensor data between the application interface format and the sensor data format. A network driver interface communicates the sensor data between the tethered sensor driver translator and a network driver of the computing device. The network driver is configured to communicate the sensor data with the remote sensor via the communications network.

### BACKGROUND

It can be challenging to control or collect data from a remote sensor without specific application programming and/or web services for interacting between the remote sensor and a mobile device. Further, a mobile device often communicates with a remote sensor through an application on the mobile device, and is unable to access the remote sensor and use remote sensor data in the same way the mobile device can access and use data from sensors located locally on the mobile device.

### SUMMARY

In at least one implementation, the disclosed technology provides a computing device for communication between an application executing at the application level of the computing device and a remote sensor located on a remote computing device. The remote sensor has a kernel level sensor interface supporting a sensor data format and is connected to the computing device via a communications network. The computing device includes an application interface supporting an application interface format. The application interface is configured to communicate sensor data with the application according to the application interface format. The computing device also includes a tethered sensor driver translator configured to translate the sensor data between the application interface format and the sensor data format. The computing device further includes a network driver interface configured to communicate the sensor data between the tethered sensor driver translator and a network driver of the computing device. The network driver is configured to communicate the sensor data formatted in the sensor data format with the remote sensor via the communications network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example primary computing device tethered to a remote sensor on a remote device.

FIG. 2 illustrates an example schematic of a primary computing device tethered to a remote sensor on a remote computing device.

FIG. 3 illustrates example communications between a primary device and a remote device with a remote sensor when the primary device is tethered to the remote sensor.

FIG. 4 illustrates example operations for communicating between an application executing at the application level of a computing device and a remote sensor located on a remote computing device.

FIG. 5 illustrates an example computing device for use in tethering a primary device to a remote sensor.

### DETAILED DESCRIPTIONS

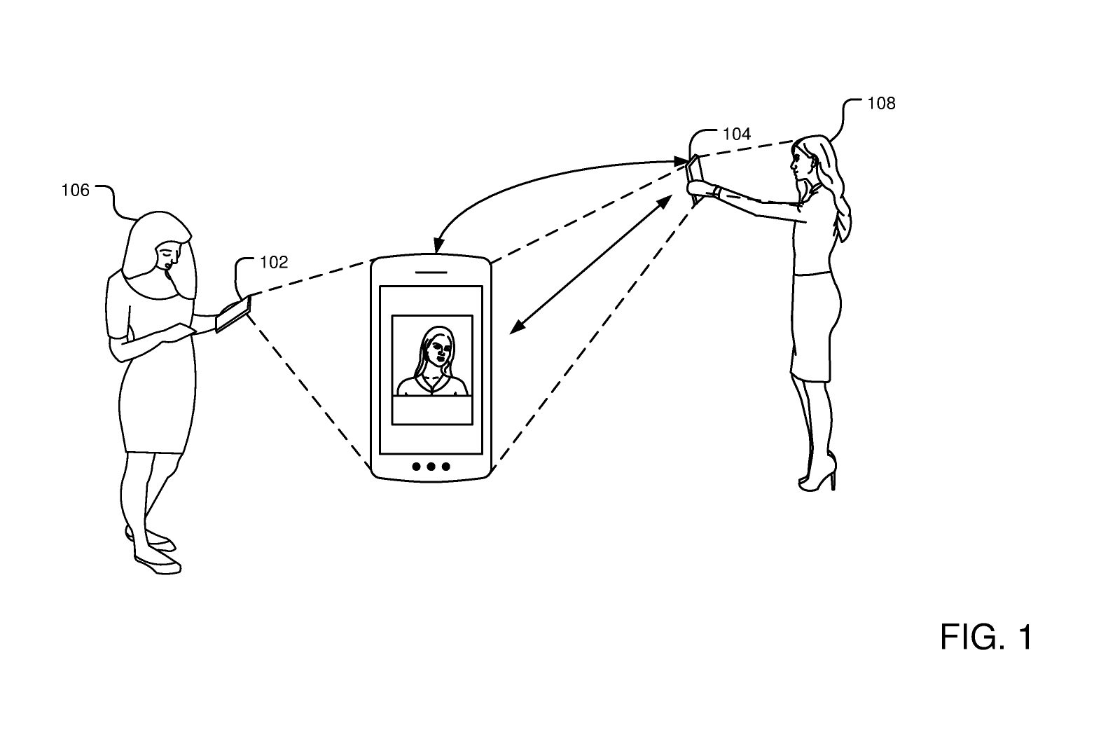

FIG. 1 illustrates an example primary computing device 102 tethered to a remote sensor on a remote computing device 104. In some situations, it is desirable to have access to a sensor on a remote device. Having access to a sensor on a remote device may, for example, allow for remote authentication. FIG. 1 shows a primary user 106 receiving remote authentication from a remote user 108. If, for example, the remote user 108 has given the primary user 106 permission to access the bank account of the remote user 108, remote authentication may be used to demonstrate that the primary user 106 has permission from the remote user 108 to access the account.

The primary user 106 sends a request to the remote computing device 104 through the primary computing device 102. In this implementation, the request is a request to access the camera of the remote computing device 104 to provide facial remote authentication. In other implementations, other sensors may be accessed, such as a microphone, touch sensor, temperature sensor, or any other sensor that can collect data about the environment around the remote computing device 104. The request from the primary computing device 102 may be sent using an application running on the primary computing device 102. In some implementations, the application on the primary computing device 102 allows the primary user 106 to select whether to use an image from a camera located on the primary computing device 102 or to send a request to a remote camera located on the remote computing device 104.

The primary computing device 102 processes the request from the application on the primary computing device 102 using a tethered sensor driver, a primary network driver, and a primary network interface card (NIC). The application on the primary computing device 102 sends the request through an application programming interface (API). The tethered sensor driver also communicates with the API to receive the request. The tethered sensor driver translates the request from an application interface format compatible with the application to a sensor data format compatible with the remote camera on the remote computing device 104. The primary network driver and the primary NIC then prepare the request for communication to the remote computing device 104 over a communications network and communicate the request to the remote computing device 104 over the communications network. The communications network may be, without limitation, a cellular network or WiFi network.

The remote computing device 104 receives the request at a remote NIC. The remote NIC and a remote network driver convert the request from the format for communication back to the sensor data format compatible with the remote camera. The remote network driver then sends the request to the remote camera through a remote camera driver. In some implementations, once the remote camera receives the request, the primary user 106 may be able to control the remote camera using the primary computing device 102. For example, the primary user 106 may have the ability to zoom in and out and control when the camera captures an image. When the remote camera captures an image, the remote computing device 104 sends the captured image back to the primary computing device 102. For authentication purposes, the remote computing device 104 may send authentication information with the image to the primary computing device 102. Authentication information may include, for example, data indicating the time the image was captured or data indicating that the image was captured in response to a token sent by the primary computing device 102 with the request for the remote camera to capture an image.

The remote device 104 sends the captured image back to the primary computing device 102. The remote sensor sends the captured image to the remote network driver through the remote camera driver. The remote network driver prepares the captured image data for communication to the primary computing device 102 over the communications network. For example, the remote network driver may break the captured image data into packets suitable for communication over the communications network. The remote network driver sends the captured image data to the remote NIC for communication to the primary computing device 102 over the communications network.

The captured image data is received by the primary NIC. The primary NIC and the primary network driver convert the captured image data from the format used for transmission to its original format. The tethered sensor driver then receives the captured image data from the primary network driver. The tethered sensor driver translates the captured image data back to the application interface format and the original application receives the captured image data through the API accessible to the tethered sensor driver.

Using the tethered sensor driver, the application on the primary computing device 102 may control the remote camera on the remote device 104 in the same manner as if the application was using a camera located locally on the primary device 102. When the primary computing device 102 has access to the remote camera on the remote device 104 through the tethered sensor driver, any application on the primary computing device 102 may access the remote camera on the remote device 104 in the same way as the applications would access the camera located locally on the primary computing device 102. The application sends a request for access to the API. To access the remote camera, the request goes to the tethered camera driver rather than a local camera driver. The applications on the primary computing device 102 execute on an application layer of the primary computing device 102. The tethered sensor driver and the local sensor driver execute on a kernel level of the operating system of the primary computing device 102.

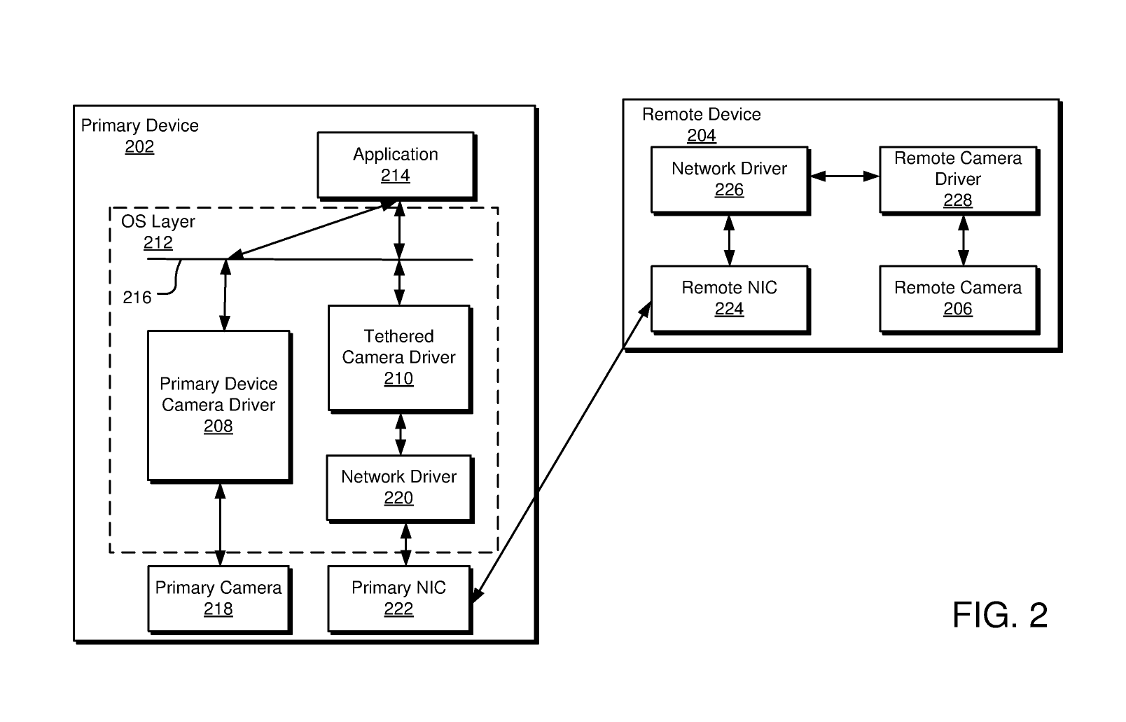

FIG. 2 illustrates an example schematic of a primary computing device 202 tethered to a remote sensor on a remote computing device 204. In the implementation shown in FIG. 2, the remote sensor is a remote camera 206. In other implementations, other sensors may be the remote sensor including, without limitation, a microphone, a temperature sensor, or an infrared sensor. The primary computing device 202 includes a primary device camera driver 208 and a tethered camera driver 210, both executing at a kernel level of an operating system (OS) layer 212 of the primary computing device 202. Both the primary device camera driver 208 and the tethered camera driver 210 may communicate data with applications on the primary device 202 (e.g., an application 214) executing on an application level through an API 216 when the data is in an application interface format. Similarly, the application 214, or other applications executing on the primary computing device 202 may communicate data in the application interface format with the primary device camera driver 208 and the tethered camera driver 210 through the API 216.

The application 214 on the primary device 202 sends to and receives sensor data from the tethered camera driver 210 or the primary device camera driver 208. Sensor data may be, without limitation, a request for a sensor to capture data, sensed data captured by a sensor, a token to access a sensor, sensor commands to control a sensor, confirmation of receipt of sensor commands or requests, or authentication information. For example, the application 214 may send a request for the remote camera 206 to capture data to the tethered camera driver 210 through the API 216. The application 214 may receive sensed data captured by the remote camera 206 from the tethered camera driver 210 through the API 216.

In one implementation, the sensor data sent from the application 214 to the primary device camera driver 208 or to the tethered camera driver 210 is a request for a sensor to capture data. If the user wants to capture data using the primary camera 218, the request is sent to the primary device camera driver 208. The primary device camera driver 208 translates and sends requests from the application 214 to the primary camera 218 located on the primary device 202. When the user wants to capture data using the remote camera 206, the request is sent to the tethered camera driver 210. The tethered camera driver 210 handles requests from the application 214 to access the remote camera 206 located on the remote device 204.

When the application 214 sends a request to the primary device camera driver 208 through the API 216, the primary device camera driver 208 translates the request from the application interface format to a format compatible with the primary camera 218. The primary camera 218 then captures an image and sends the image back to the primary device camera driver 208. The primary device camera driver 208 then translates the image to the application interface format and returns the image back to the requesting application 214. In some implementations, after the application 214 receives the image, the application 214 may further process the image.

When the user wants to capture data using the remote camera 206, the primary device 202 first connects to the remote device 204. In some implementations, the primary device 202 may locate the remote device 204 through WiFi or Bluetooth. Using the WiFi or Bluetooth, the primary device 202 establishes a connection to the remote device 204 before sending a request to capture data using the remote camera 206 on the remote device 204.

In some implementations, before the primary device 202 connects to the remote device 204, authentication credentials are exchanged between the primary device 202 and the remote device 204. For example, the primary device 202 may send an authentication credential to the remote device 204 along with the request to connect to the remote device 204 for use of the remote camera 206. If the primary device 202 sends the correct authentication credential, the remote device 204 may respond by establishing a connection with the primary device 202. In some implementations, the remote device 204 returns authentication information with the image captured by the remote camera 206, indicating that the image was captured by the remote camera 206 at a particular time or in a particular location.

The application 214 sends requests (or other sensor data) to the tethered camera driver 210 through the API 216. The tethered camera driver 210 receives the sensor data at an application interface in an application interface format. The application interface format is compatible with the application 214, the API 216, and the application interface of the tethered camera driver 210. Both the application 214 and the application interface of the tethered camera driver 210 communicates with the API 216 to exchange the sensor data. After receiving the request at the application interface of the tethered camera driver 210, the tethered camera driver 210 translates the sensor data from the application interface format to a sensor data format. The sensor data format is a format compatible with the remote camera 206. After translating the sensor data to the sensor data format, the tethered camera driver 210 passes the sensor data formatted sensor data to a primary network driver 220 through a network driver interface of the tethered camera driver 210.

The primary network driver 220 prepares the sensor data formatted sensor data for communication to the remote device 204 via a communications network. For example, in one implementation, the primary network driver 220 may break a large piece of sensor data into smaller packets for communication via the communications network. The primary network driver 220 may add other data to the sensor data to allow the sensor data to be communicated via the communications network. The primary network driver 220 then passes the sensor data to the primary NIC 222. The primary NIC 222 further prepares the sensor data for communication via the communications network by adding additional network protocol data to the sensor data and communicates the sensor data via the communications network. The communications network may be, for example, a cellular data network or a WiFi network.

The sensor data is received at the remote device 204 by a remote NIC 224. The remote NIC 224 removes the additional network protocol data from the sensor data. The remote NIC 224 then passes the sensor data to a remote network driver 226. The remote network driver 226 manipulates the sensor data so that it is in the original sensor data format. For example, if the primary network driver 220 broke a large piece of sensor data into smaller packets, the remote network driver 226 may convert the packets of sensor data back into the original large piece of sensor data. The remote network driver 226 then passes the sensor data formatted sensor data to the remote camera 206 through a remote camera driver 228.

The remote camera 206 then responds to the received sensor data. For example, if the sensor data is a request for the remote camera 206 to capture an image, the remote camera 206 will capture the image in response to receiving the sensor data. In some implementations, the received sensor data may allow the primary device 202 to control the remote camera 206 through the application 214 or may be a token that allows the primary device 202 to have exclusive control of the remote device 204. A token may, in some implementations, be a temporary token that allows the primary device 202 to have exclusive control of the remote device 204 or the remote camera 206. The temporary token may expire after a predetermined amount of time. When the temporary token expires, the primary device 202 may no longer have control over the remote camera 206 or the remote device 204.

In response to some sensor data, the remote camera 206 may send sensor data back to the application 214 on the primary device 202. The remote camera 206 may send, for example, without limitation, images captured by the remote camera 206, authentication information about images captured by the remote camera 206, or confirmation of receipt of a command. In one implementation, the remote camera 206 receives a request from the application 214 on the primary device 202 to capture an image. The remote camera 206 then sends the image back to the application 214 as sensor data. The remote camera 206 sends the sensor data to the remote network driver 226 through the remote camera driver 228. The remote network driver 226 receives the sensor data in the sensor data format. The remote network driver 226 prepares the sensor data formatted sensor data for communication to the primary device 202 via the communications network. For example, in one implementation, the remote network driver 226 may break a large piece of sensor data into smaller packets for communication via the communications network. The remote network driver 226 may add other data to the sensor data to allow the sensor data to be communicated via the communications network. The remote network driver 226 then passes the sensor data to the remote NIC 224. The remote NIC 224 further prepares the sensor data for communication via the communications network by adding additional network protocol data to the sensor data and communicates the sensor data via the communications network.

The primary device 202 receives the sensor data at the primary NIC 222. The primary NIC 222 removes the additional network protocol data from the sensor data. The primary NIC 222 then passes the sensor data to the primary network driver 220. The primary network driver 220 manipulates the sensor data so that it is in the original sensor data format. For example, if the remote network driver 226 broke a large piece of sensor data into smaller packets, the primary network driver 220 may convert the packets of sensor data back into the original large piece of sensor data. The tethered camera driver 210 then receives the sensor data formatted sensor data at the network interface of the tethered camera driver 210.

After the tethered camera driver 210 receives the sensor data formatted sensor data, the tethered camera driver 210 translates the sensor data from the sensor data format to the application interface format. The tethered sensor driver 210 then passes the application interface formatted sensor data from the application interface of the tethered camera driver 210 to the application 214 through the API 216. The application 214 receives the application formatted sensor data through the API 216 in the same way it would receive data captured by the primary camera 218 on the primary device 202.

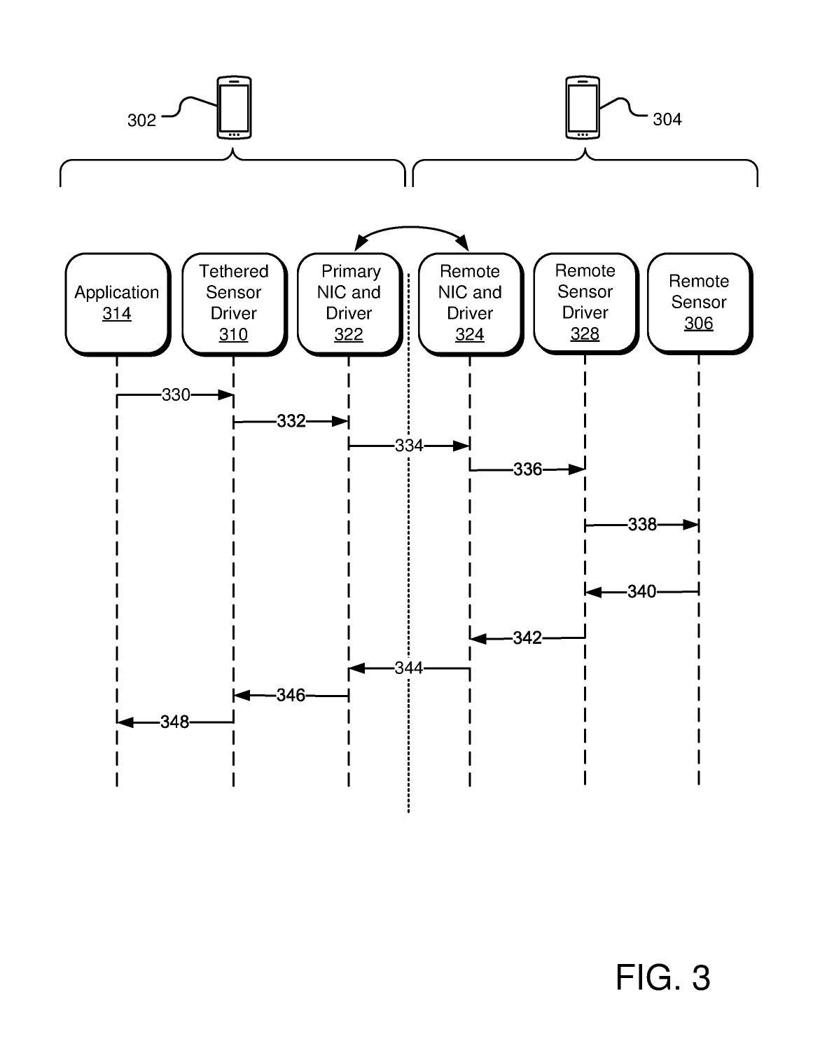

FIG. 3 illustrates example communications between a primary device and a remote device with a remote sensor when the primary device is tethered to the remote sensor. A communication 330 communicates sensor data from an application 314 executing on an application layer of a primary device 302 to a tethered sensor driver 310 executing on a kernel level of an operating system layer of the primary device 302. The sensor data in communication 330 may be, without limitation, a request for a remote sensor 306 to collect data, a command to control the remote sensor 306, or a token to allow the primary device 302 to have control over the remote sensor 306. In one implementation, the sensor data is a request for the remote sensor 306 to collect data. The sensor data communicated by the communication 330 is communicated through an API accessible to both the application 314 and an application interface of the tethered sensor driver 310. Further, the sensor data communicated by the communication 330 is in an application interface format. The application interface format may be any format that is understood by the application 314, the API, and the application interface of the tethered sensor driver 310.

After the tethered sensor driver 310 receives the sensor data in the sensor data formation, the tethered sensor driver 310 converts the sensor data to a sensor data format. The sensor data format is a format compatible with the remote sensor 306. For example, the tethered sensor driver 310 may translate a request for the remote sensor 306 to collect data from the application interface format to the sensor data format compatible with the remote sensor 306 using a tethered sensor driver translator.

A communication 332 communicates the sensor data formatted sensor data from the tethered sensor driver 310 to a primary NIC and driver 322. A network interface of the tethered sensor driver 310 communicates the sensor data in the sensor data format to the primary NIC and driver 322. After receiving the sensor data in the sensor data format from the tethered sensor driver 310, the primary NIC and driver 322 prepare the sensor data for communication to a remote NIC and driver 324 located on a remote device 304. For example, the primary driver may format the data for communication to the remote NIC and driver 324 while the primary NIC may communicate the data to the remote NIC and driver 324 via a communication network. For example, the primary driver may divide the sensor data into bits and format the bits of data with network protocol so that the data may be communicated by the primary NIC and received by the remote NIC.

A communication 334 communicates the sensor data from the primary NIC and driver 322 to the remote NIC and driver 324. The sensor data is communicated from the primary NIC and driver 322 to the remote NIC and driver 324 via a communications network. The communications network may be, for example and without limitation, a cellular data network or a WiFi network. After the remote NIC and driver 324 receive the sensor data from the primary NIC and driver 322 via the communication network, the remote NIC and driver 324 format the sensor data so that the sensor data is again in the sensor data format. For example, the remote NIC may receive the sensor data as concatenated data with network protocol. The remote driver may remove the network protocol and may concatenate the bits of data so that the data is again in the sensor data format.

A communication 336 communicates the sensor data from the remote NIC and driver 324 to a remote sensor driver 328. The remote driver communicates the sensor data to the remote sensor driver 328 in the sensor data format. The remote sensor driver 328 acts as an interface for the remote sensor 306. A communication 338 communicates the sensor data from the remote sensor driver 328 to the remote sensor 306.

When the remote sensor 306 receives the sensor data, the remote sensor 306 may perform an operation based on the received sensor data. For example, if the received sensor data is a request for the remote sensor to collect data, the remote sensor 306 will collect data in response to receiving the sensor data. After the remote sensor 306 has processed the received sensor data, the remote sensor 306 communicates the sensor data back to the application 314. The sensor data communicated back to the application 314 may be without limitation, captured sensor data, confirmation of receipt or execution of commands by the remote sensor 306, or authentication information. A communication 340 communicates sensor data from the remote sensor 306 to the remote sensor driver 328. The sensor data is communicated from the remote sensor 306 to the remote sensor driver 328 in the sensor data format.

A communication 342 communicates the captured sensor data from the remote sensor driver 328 to the remote NIC and driver 324. The remote NIC and driver 324 then prepare the sensor data for communication to the primary NIC and driver 322 located on the primary device 302. For example, the remote driver may format the data for communication to the primary NIC and driver 322 while the remote NIC communicates the data to the primary NIC and driver 322 via a communication network. For example, the remote driver may divide the sensor data into bits and format the bits of data with network protocol so that the data may be communicated by the remote NIC and received by the primary NIC. A communication 344 communicates the sensor data from the remote NIC and driver 324 to the primary NIC and driver 322. The primary NIC and driver 322 format the sensor data so that the sensor data is again in the sensor data format. For example, the primary NIC may remove additional network data added by the remote NIC so that the sensor data could be communicated via the communications network. The primary driver may take data packets created by the remote driver and return the sensor data to the sensor data format.

A communication 346 communicates the sensor data from the primary NIC and driver 322 to the tethered sensor driver 310. The tethered sensor driver 310 receives the sensor data at the network interface of the tethered sensor driver 310. The tethered sensor driver 310 then translates the sensor data from the sensor data format to the application interface format.

A communication 348 communicates the sensor data from the tethered sensor driver 310 to the application 314. The sensor data is communicated through an API in the application interface format. The application 314 receives the sensor data in the same way that it would receive the sensor data from a sensor on the primary device 302.

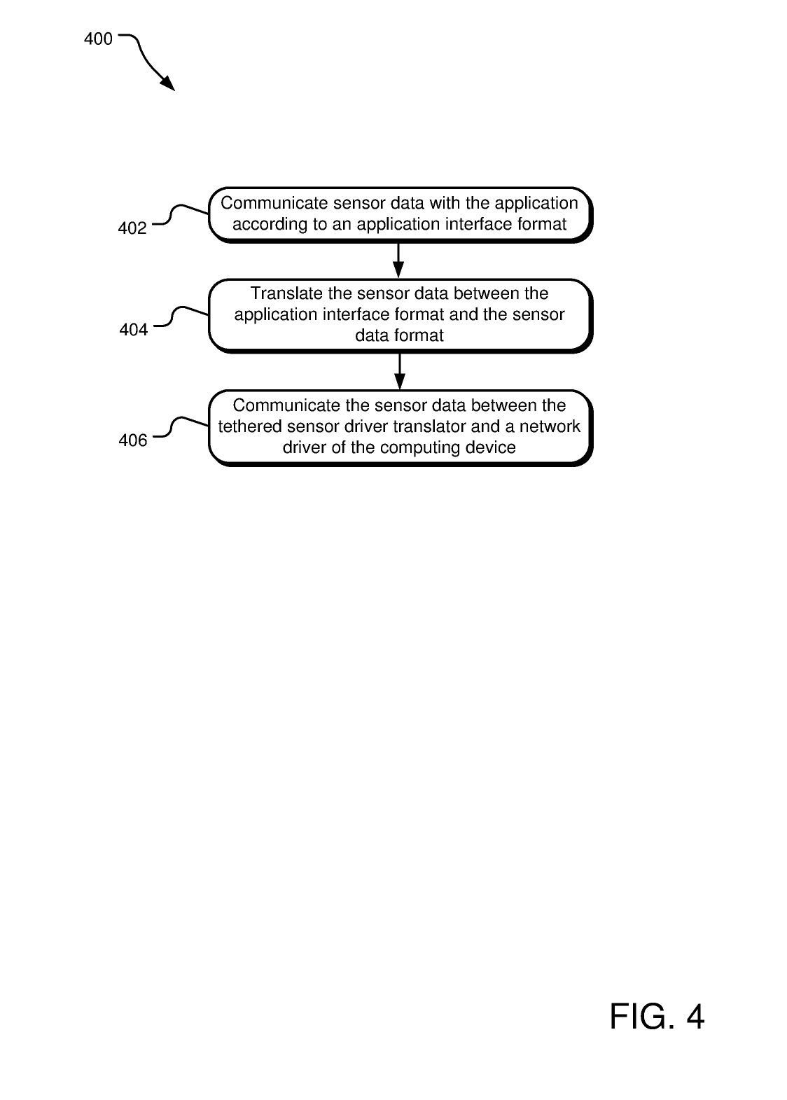

FIG. 4 illustrates example operations 400 for communicating between an application executing at the application level of a computing device and a remote sensor located on a remote computing device. A first communicating operation 402 communicates sensor data with an application in an application interface format. The sensor data may be data being sent from the application to the remote sensor or data being sent from the remote sensor to the application. In one implementation, the sensor data is a request for the remote sensor to collect data. The request for the remote sensor to collect information is received from the application in the application interface format through an API accessible by the application and an application interface. In another implementation, the sensor data may be sensor data collected by the remote sensor being communicated to the application. The sensor data collected by the remote sensor may be returned to the application in the application interface format through the API accessible by the application and the application interface. In other implementations, sensor data may include other data related to the remote sensor, such as an access credential or a time of collection of information by the remote sensor.

A translating operation 404 translates the sensor data between the application interface format and the sensor data format. In one implementation, the sensor data may be a request for the remote sensor to collect information, where the request is received from the application in the application interface format. The request is then translated from the application interface format to the sensor data format. In another implementation, the sensor data may be information collected by the remote sensor. The information collected by the remote sensor is then translated from the sensor data format to the application interface format to be returned to the application.

A second communicating operation 406 communicates the sensor data between the tethered sensor driver translator and a network driver of the computing device. The sensor data communicated between the tethered sensor driver translator and the network driver is communicated in the sensor data format. After the second communicating operation 406, the network driver formats the sensor data for communication to the remote device over a communications network through a remote NIC.

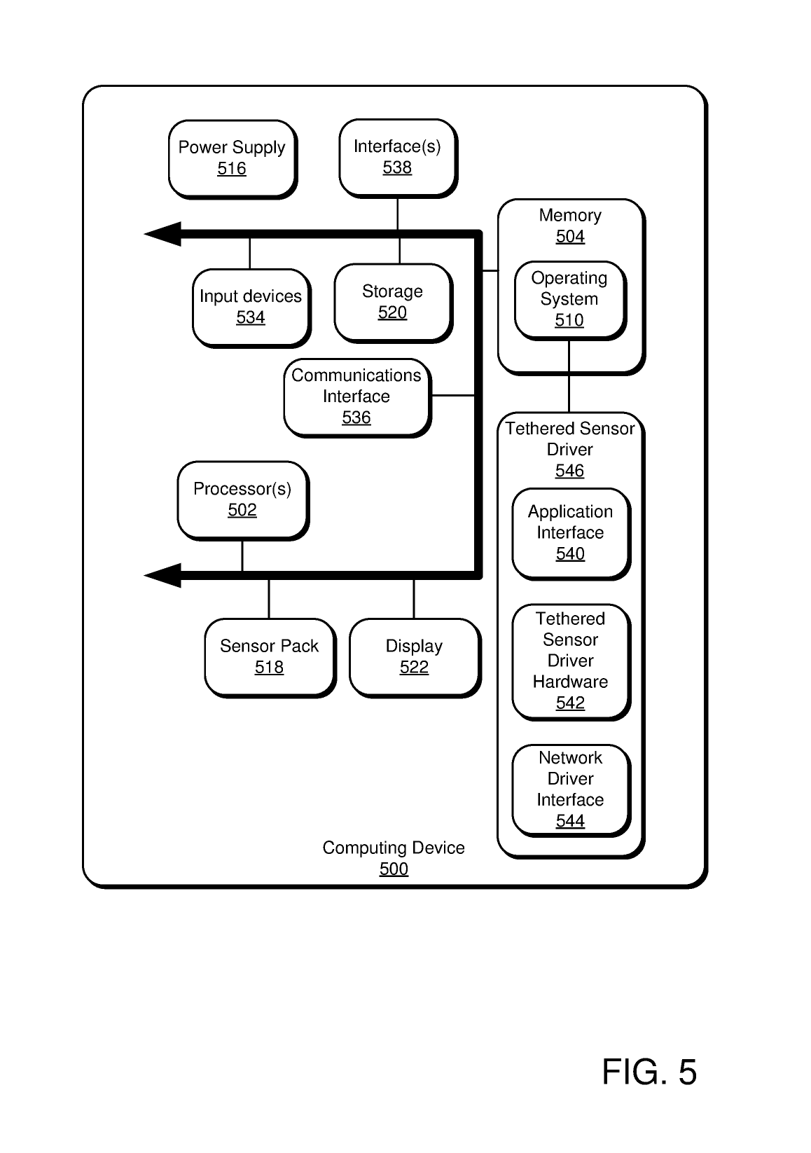

FIG. 5 illustrates an example computing device 500 for use in communication between an application executing at an application level of the computing device 500 and a remote sensor located on a remote device. The example computing device 500 may be used to process audio signals remotely to provide multi-dimensional audio from the audio transmitting device to the audio outputting device. The computing device 500 may be a client device, such as a laptop, mobile device, desktop, tablet, or a server/cloud device. The computing device 500 includes one or more processor(s) 502, and a memory 504. The memory 504 generally includes both volatile memory (e.g., RAM) and non-volatile memory (e.g., flash memory). An operating system 510 resides in the memory 504 and is executed by the processor(s) 502.

One or more modules or segments, such as a tethered sensor driver 546 are loaded into the operating system 510 on the memory 504 and/or storage 520 and executed by the processor(s) 502. The modules may include the tethered sensor driver 546 implemented by an application interface 540, tethered sensor driver hardware 542, and a network driver interface 544. The tethered sensor driver 546 communicates sensor data with an application executing at an application level of the computing device 500. The tethered sensor driver 546 includes the application interface 540, the tethered sensor hardware 542, and the network driver interface 544. The application interface 540 supports an application interface format and is configured to communicate sensor data with the application according to the application interface format. the tethered sensor driver hardware 542 is configured to translate the sensor data between the application interface format and a sensor data format. The network driver interface 544 is configured to communicate the sensor data between the tethered sensor hardware 542 and a network driver of the computing device 500. Data such as user preferences, hardware configurations, and hardware responses may be stored in the memory 504 or storage 520 and may be retrievable by the processor(s) 502 for use by the application interface 540, the tethered sensor driver hardware 544, and the network driver interface 546. The storage 520 may be local to the computing device 500 or may be remote and communicatively connected to the computing device 500 and may include another server. The storage 520 may store resources that are requestable by client devices (not shown).

The computing device 500 includes a power supply 516, which is powered by one or more batteries or other power sources and which provides power to other components of the computing device 500. The power supply 516 may also be connected to an external power source that overrides or recharges the built-in batteries or other power sources.

The computing device 500 may include a communications interface 536 to provide network connectivity (e.g., mobile phone network, Wi-Fi®, Bluetooth®) to one or more other servers and/or client devices (e.g., mobile devices, desktop computers, or laptop computers). The computing device 500 may use the communications interface 536 and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538 such as a serial port interface, parallel port, or universal serial bus (USB). The computing device 500 may further include a display 522 such as a touch screen display.

The computing device 500 may include a variety of tangible processor-readable storage media and intangible processor-readable communication signals. Tangible processor-readable storage can be embodied by any available media that can be accessed by the computing device 500 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

An example computing device for communication between an application executing at an application level of the computing device and a remote sensor on a remote computing device is provided. The remote sensor has a kernel level sensor interface supporting a sensor data format and is connected to the computing device via a communications network. The computing device includes one or more processors and an application interface executed by the one or more processors at the kernel level of an operating system of the computing device. The application interface supports an application interface format and is configured to communicate sensor data with the application according to the application interface format. The computing device also includes a tethered sensor driver translator executed by the one or more processors at the kernel level of the operating system of the computing device. The tethered sensor driver is configured to translate the sensor data between the application interface format and the sensor data format. The computing device further includes a network driver interface executed by the one or more processors at the kernel level of the operating system of the computing device. The network driver interface is configured to communicate the sensor data between the tethered sensor driver translator and a network driver of the computing device. The network driver is configured to communicate the sensor data formatted in the sensor data format with the remote sensor via the communications network.

An example computing device of any previous computing device is provided, where the sensor data includes a command from the application to the remote sensor commanding the remote sensor to remotely sense data.

An example computing device of any previous computing device is provided, where the sensor data includes remotely sensed data captured by the remote sensor.

An example computing device of any previous computing device is provided, where the sensor data includes authentication information.

An example computing device of any previous computing device is provided, where the network driver interface is further configured to communicate a temporary token to the network driver. The network driver is configured to communicate the temporary token to the remote sensor to allow for temporary control of the remote sensor by the application on the computing device. The temporary token expires after the passage of a predetermined amount of time.

An example computing device of any previous computing device is provided, where the temporary token allows for temporary nonexclusive control of the remote sensor by the application on the computing device.

An example computing device of any previous computing device is provided, where the temporary token allows for temporary exclusive control of the remote sensor by the application on the computing device.

An example method is provided for communication between an application executing at an application level of a computing device and a remote sensor located on a remote computing device. The remote sensor has a kernel level sensor interface supporting a sensor data format and is connected to the computing device via a communications network. The method includes communicating sensor data with the application according to an application interface format. The method also includes translating the sensor data between the application interface format and the sensor data format. The method further includes communicating the sensor data between a tethered sensor driver and a network driver of the computing device. The network driver is configured to communicate the sensor formatted sensor data with the remote sensor via the communications network.

An example method of any previous method is provided, where the sensor data includes a command from the application to the remote sensor commanding the remote sensor to remotely sense data.

An example method of any previous method is provided, where the sensor data includes remotely sensed data captured by the remote sensor.

An example method of any previous method is provided, where the sensor data includes authentication information.

An example method of any previous method is provided, further including communicating a temporary token to the network driver. The network driver is configured to communicate the temporary token to the remote sensor to allow for temporary control of the remote sensor by the application on the computing device. The temporary token expires after the passage of a predetermined amount of time.

An example method of any previous method is provided, where the temporary token allows for temporary nonexclusive control of the remote sensor by the application on the computing device.

An example method of any previous method is provided, where the temporary token allows for temporary exclusive control of the remote sensor by the application on the computing device.

An example system for communication between an application executing at an application level of a computing device and a remote sensor located on a remote computing device is provided. The remote sensor has a kernel level sensor interface supporting a sensor data format and is connected to the computing device via a communications network. The system includes means for communicating sensor data with the application according to an application interface format. The system further includes means for translating the sensor data between the application interface format and the sensor data format. The system further includes means for communicating the sensor data between a tethered sensor driver translator and a network driver of the computing device. The network driver is configured to communicate the sensor data formatted sensor data with the remote sensor via the communications network.

An example system of any preceding system is provided, where the sensor data includes a command from the application to the remote sensor commanding the remote sensor to remotely sense data.

An example system of any preceding system is provided, where the sensor data includes remotely sensed data captured by the remote sensor.

An example system of any preceding system is provided, where the sensor data includes authentication information.

An example system of any preceding system further includes means for communicating a temporary token to the network driver. The network driver is configured to communicate the temporary token to the remote sensor to allow for temporary control of the remote sensor by the application on the computing device. The temporary token expires after the passage of a predetermined amount of time.

An example system of any preceding system is provided, where the temporary token allows for temporary nonexclusive control of the remote sensor by the application on the computing device.

An example system of any preceding system is provided, where the temporary token allows for temporary exclusive control of the remote sensor by the application on the computing device.

Example one or more tangible processor-readable storage media are embodied with instructions for executing on one or more processors and circuits of a computing device a process for communication between an application executing at an application level of a computing device and a remote sensor located on a remote computing device, the remote sensor having a kernel level sensor interface supporting a sensor data format and being connected to the computing device via a communications network. The process includes communicating sensor data with the application according to an application interface format. The process further includes translating the sensor data between the application interface format and the sensor data format. The process also includes communicating the sensor data between the tethered sensor driver translator and a network driver of the computing device. The network driver is configured to communicate the sensor data formatted sensor data with the remote sensor via the communications network.

Another example one or more tangible processor-readable storage media are embodied with instructions for executing on one or more processors and circuits of a device a process of any preceding process, where the sensor data includes a command from the application to the remote sensor commanding the remote sensor to remotely sense data.

Another example one or more tangible processor-readable storage media are embodied with instructions for executing on one or more processors and circuits of a device a process of any preceding process, where the sensor data includes remotely sensed data captured by the remote sensor.

Another example one or more tangible processor-readable storage media are embodied with instructions for executing on one or more processors and circuits of a device a process of any preceding process, where the sensor data includes authentication information.

Another example one or more tangible processor-readable storage media are embodied with instructions for executing on one or more processors and circuits of a device a process of any preceding process, further including communicating a temporary token to the network driver. The network driver is configured to communicate the temporary token to the remote sensor to allow for temporary control of the remote sensor by the application on the computing device.

Another example one or more tangible processor-readable storage media are embodied with instructions for executing on one or more processors and circuits of a device a process of any preceding process, where the temporary token expires after the passage of a predetermined amount of time.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computing device for communication between an application executing at an application level of the computing device and a remote sensor located on a remote computing device, the remote sensor having a kernel level sensor interface supporting a sensor data format and being connected to the computing device via a communications network, the computing device comprising:
one or more processors;
an application interface executed by the one or more processors at the kernel level of an operating system of the computing device and supporting an application interface format, the application interface configured to communicate sensor data with the application according to the application interface format;
a tethered sensor driver translator executed by the one or more processors at the kernel level of the operating system of the computing device, the tethered sensor driver translator configured to translate the sensor data between the application interface format and the sensor data format; and
a network driver interface executed by the one or more processors at the kernel level of the operating system of the computing device, the network driver interface configured to communicate the sensor data between the tethered sensor driver translator and a network driver of the computing device, the network driver being configured to communicate the sensor data formatted in the sensor data format with the remote sensor via the communications network.

2. The computing device of claim 1, wherein the sensor data includes a command from the application to the remote sensor commanding the remote sensor to remotely sense data.

3. The computing device of claim 1, wherein the sensor data includes remotely sensed data captured by the remote sensor.

4. The computing device of claim 3, wherein the sensor data includes authentication information.

5. The computing device of claim 1, wherein the network driver interface is further configured to communicate a temporary token to the network driver, the network driver being configured to communicate the temporary token to the remote sensor to allow for temporary control of the remote sensor by the application on the computing device, the temporary token expiring after the passage of a predetermined amount of time.

6. The computing device of claim 5, wherein the temporary token allows for temporary nonexclusive control of the remote sensor by the application on the computing device.

7. The computing device of claim 5, wherein the temporary token allows for temporary exclusive control of the remote sensor by the application on the computing device.

8. A method for communication between an application executing at an application level of a computing device and a remote sensor located on a remote computing device, the remote sensor having a kernel level sensor interface supporting a sensor data format and being connected to the computing device via a communications network, the method comprising:
communicating sensor data with the application according to an application interface format;
translating the sensor data between the application interface format and the sensor data format; and
communicating the sensor data between a tethered sensor driver translator and a network driver of the computing device, the network driver being configured to communicate the sensor data formatted in the sensor data format with the remote sensor via the communications network.

9. The method of claim 8, wherein the sensor data includes a command from the application to the remote sensor commanding the remote sensor to remotely sense data.

10. The method of claim 8, wherein the sensor data includes remotely sensed data captured by the remote sensor.

11. The method of claim 8, wherein the sensor data includes authentication information.

12. The method of claim 8, further comprising:
communicating a temporary token to the network driver, the network driver being configured to communicate the temporary token to the remote sensor to allow for temporary control of the remote sensor by the application on the computing device, the temporary token expiring after the passage of a predetermined amount of time.

13. The method of claim 12, wherein the temporary token allows for temporary nonexclusive control of the remote sensor by the application on the computing device.

14. The method of claim 12, wherein the temporary token allows for temporary exclusive control of the remote sensor by the application on the computing device.

15. One or more tangible processor-readable storage media embodied with instructions for executing on one or more processors and circuits of a computing device a process for communication between an application executing at an application level of the computing device and a remote sensor located on a remote computing device, the remote sensor having a kernel level sensor interface supporting a sensor data format and being connected to the computing device via a communications network, the process comprising:
communicating sensor data with the application according to an application interface format;
translating the sensor data between the application interface format and the sensor data format; and
communicating the sensor data between a tethered sensor driver translator and a network driver of the computing device, the network driver being configured to communicate the sensor data formatted sensor data with the remote sensor via the communications network.

16. The one or more tangible processor-readable storage media of claim 15, wherein the sensor data includes a command from the application to the remote sensor commanding the remote sensor to remotely sense data.

17. The one or more tangible processor-readable storage media of claim 15, wherein the sensor data includes remotely sensed data captured by the remote sensor.

18. The one or more tangible processor-readable storage media of claim 17, wherein the sensor data includes authentication information.

19. The one or more tangible processor-readable storage media of claim 15, wherein the process further comprises:
communicating a temporary token to the network driver, the network driver being configured to communicate the temporary token to the remote sensor to allow for temporary control of the remote sensor by the application on the computing device.

20. The one or more tangible processor-readable storage media of claim 19, wherein the temporary token expires after the passage of a predetermined amount of time.
